(19) United States
(12) Patent Application Publication
(10) Pub. No.: US 2019/0016989 A1
(43) Pub. Date: Jan. 17, 2019

(54) ENHANCED ESSENTIAL OIL EXTRACTION, RECOVERY, AND PURGE SYSTEM AND METHOD

(71) Applicant: ESSENTIAL INNOVATIONS, INC., Edmonds, WA (US)

(72) Inventor: Casey STEELE, Edmonds, WA (US)

(21) Appl. No.: 16/133,391

(22) Filed: Sep. 17, 2018

Related U.S. Application Data
(63) Continuation-in-part of application No. 15/610,346, filed on May 31, 2017.

(51) Int. Cl. C11B 1/10; B01D 11/02

(52) U.S. Cl. CPC C11B 1/10; B01D 11/0288; B01D 11/0296

(57) ABSTRACT

A system and method of extracting fluids from biomass material through the use of closed system capable of both low pressure and pressurized extraction that utilizes a combined vacuum and fluid collection tank, thus enabling different levels of pressure and vacuum to achieve a wide range of temperatures and allowing for variations in the chemical properties of the resultant extracted fluid. Although vacuum is preferred for safety, pressure is available when necessary, such as due to higher levels of filtration in which the use of vacuum is insufficient.

### BACKGROUND

### Technical Field

The present disclosure pertains to a system for extracting fluids from biomass material and, more particularly, to a dual vacuum-pressure closed loop extraction system that utilizes a novel combination of vacuum and pressure to enable extraction of a wide variety of compounds from the biomass material and enable recovery and recycling of solvent used in the process.

### Description of the Related Art

Biomass materials, such as plants, include fluids, such as oils and other minerals and compounds, that have various uses and benefits apart from the fibrous plant material itself. Certain compounds, such as essential oils, once removed from the plant material, can be used in foods, medicines, and other products. Typical methods of extracting compounds use highly pressurized systems to force a solvent through the plant material. These systems can be expensive, ineffective, and very dangerous due to the use of high pressures.

### BRIEF SUMMARY

In accordance with the present disclosure a system and method of extracting essential oils from plant material through the use of a vacuum closed system employing an oil separation kettle is provided.

In accordance with one aspect of the present disclosure, a device is provided that includes a container having an exterior sidewall enclosing an interior space, a removable dish, a first port to receive steam, a second port to exhaust steam, a third port to receive a mixture of extracted oil and solvent, and a fourth port to output solvent vapor, the container further including an interior jacket formed on the sidewall and capable of receiving heated fluid, such as oil or steam, to heat the interior space and extracted oil in the interior space to a temperature that causes solvent in the extracted oil to evaporate and form a vapor.

In accordance with another aspect of the present disclosure, the container has an open bottom and the removable dish is attached to the container to close the open bottom and collect essential oil.

In accordance with a further aspect of the present disclosure, the device further includes an insulated space between the jacket and the exterior sidewall of the container.

In accordance with yet another aspect of the present disclosure, a system is provided that includes a solvent source, a material container structured to contain plant material, the material container in fluid communication with the solvent source, a filter system in fluid communication with the material container, and an oil separation kettle in fluid communication with the filter system, the oil separation kettle including a heat jacket capable of heating the kettle.

In accordance with another aspect of the present disclosure, the system includes a condenser coupled to the kettle and structured to receive vapor from the kettle and reduce the vapor to a liquid, a collection tank coupled to the condenser and structured to receive the liquid from the condenser, and a vacuum pump in fluid communication with the collection tank and structured to remove air from within the collection tank and pull solvent from the solvent source through the plant material in the material container to extract oil from the plant material and move the extracted oil into the kettle.

In accordance with a further aspect of the present disclosure, the kettle is capable of receiving a heated fluid, such as steam or oil, into the heat jacket to cause heating of the kettle and contents of the kettle. Ideally the kettle is capable of being heated by steam to a temperature that causes solvent to evaporate in the kettle.

In accordance with still yet another aspect of the present disclosure, the system further includes a source of heated fluid, such as steam or oil, coupled to the material container.

In accordance with another aspect of the present disclosure, a method is provided that includes introducing plant material into a material container; introducing a cooling liquid into the material container; providing a solvent for introduction into the material container; creating a vacuum in a kettle that is in fluid communication with the material container, and heating the kettle; and pulling the solvent through the plant material to extract oil from the plant material and pulling the mixture of solvent and extracted oil into the kettle with the vacuum from the material container and separating the solvent from the oil by heating the kettle to a temperature that causes the solvent to evaporate out of the mixture of solvent and oil and form a solvent vapor.

In accordance with another aspect of the present disclosure, the method further includes removing the solvent vapor from the kettle, condensing the solvent vapor into a liquid solvent, and collecting the liquid solvent in a collection tank.

In accordance with still yet another aspect of the present disclosure, the heating the kettle includes introducing a heated fluid, such as steam or oil, into a jacket on the kettle to heat the kettle.

In accordance with a further aspect of the present disclosure, the cooling liquid is liquid nitrogen, synthetic fluids or glycol and the solvent is an alcohol-based solvent.

In accordance with yet another aspect of the present disclosure, A processing system for biomass material, the system including a material vessel capable of receiving the biomass material, an evaporator vessel coupled to the material vessel, a condenser coupled to the evaporator vessel, a storage tank for solvent coupled to the material vessel, a source of reduced air pressure coupled to the condenser and selectively coupleable to the storage tank, the reduced air pressure source capable of creating a reduced air pressure in the condenser that is applied to the material vessel through the evaporator vessel to draw solvent from the solvent tank through the biomass material to thereby draw a fluid mixture of solvent and oil from the biomass material into the evaporator vessel, a source of positive air or inert gas pressure coupled to the storage tank that is capable of creating an increased air pressure in the storage tank to push solvent from the solvent tank through the biomass material to thereby draw a fluid mixture of solvent and oil from the biomass material into the evaporator vessel, and a heating device coupled to the material vessel and the evaporator vessel and capable of applying heat to the material vessel and to the evaporator vessel.

In accordance with a further aspect of the present disclosure, the system includes a cooling device coupled to the storage tank and capable of cooling solvent in the storage tank. Ideally the cooling device is coupled to the condenser to transfer heat with the condenser via an exchange of fluids. And preferably, the source of reduced air pressure is a vacuum tank coupled to the condenser and selectively coupled to the storage tank, and a vacuum pump coupled to the vacuum tank.

In accordance with an additional aspect of the present disclosure, a method is provided A method of extracting fluids from biomass material using a processing system for biomass material that includes a material vessel capable of receiving the biomass material, an evaporator vessel coupled to the material vessel, a condenser coupled to the evaporator vessel, a storage tank for solvent coupled to the material vessel, a source of reduced air pressure coupled to the condenser and selectively coupleable to the storage tank, the vacuum source capable of creating a reduced air pressure in the condenser that is applied to the material vessel through the evaporator vessel to draw solvent from the solvent tank through the biomass material to thereby draw a fluid mixture of solvent and oil from the biomass material into the evaporator vessel, a source of positive air pressure coupled to the storage tank that is capable of creating an increased air pressure in the storage tank to push solvent from the solvent tank through the biomass material to thereby draw a fluid mixture of solvent and oil from the biomass material into the evaporator vessel, and a source of heat coupled to the material vessel and the evaporator vessel and capable of applying heat to the material vessel and to the evaporator vessel, the method include supplying solvent to the storage tank, supplying the biomass material to the material vessel, applying one of either a reduced air pressure with the vacuum source or increased air pressure from the pressure source to the storage tank to force the solvent through the biomass material in the material vessel and draw or push, respectively, a fluid mixture of solvent and biomass oils from the biomass material into the evaporator vessel, and heating the material vessel and the evaporator vessel to dry remaining biomass material in the material vessel and to heat the fluid mixture in the evaporator vessel to separate solvent from the fluid mixture.

In accordance with still yet another aspect of the present disclosure, the method includes receiving the liquid solvent from the condenser into the vacuum tank, and draining or pumping the liquid solvent from the vacuum tank into the storage tank.

In accordance with another aspect of the present disclosure, the method includes applying increased air pressure to the storage tank with air or inert gas pressure from a pressure pump or gas cylinder. Preferably, applying increased air pressure or reduced air pressure includes applying a continuous reduced air pressure to the condenser to draw solvent from the storage tank through the material vessel and draw the fluid mixture from the material vessel into the evaporator vessel and to draw vaporized solvent from the evaporator vessel into the condenser and to the vacuum tank.

In accordance with a further aspect of the present disclosure, a process is provided for extracting fluid from biomass material using a system that includes a material vessel capable of receiving the biomass material, an evaporator vessel coupled to the material vessel, a condenser coupled to the evaporator vessel, a storage tank for solvent coupled to the material vessel, a vacuum pump coupled to the condenser and selectively coupleable to the storage tank, the vacuum pump capable of creating a reduced air pressure in the condenser that is applied to the material vessel through the evaporator vessel to draw solvent from the solvent tank through the biomass material to thereby draw a fluid mixture of solvent and oil from the biomass material into the evaporator vessel, a source of pressure coupled to the storage tank that is capable of creating an increased air pressure in the storage tank to push solvent from the solvent tank through the biomass material to thereby draw a fluid mixture of solvent and oil from the biomass material into the evaporator vessel, a heating source coupled to the material vessel and the evaporator vessel and capable of applying heat to the material vessel and to the evaporator vessel, and a cooling source coupled to the storage tank and the condenser to cool solvent in the storage tank, the process including:

introducing biomass material into the material vessel, extracting fluid from the biomass material using solvent from the storage tank by one of either:
creating a continuous reduced air pressure with the vacuum pump in the condenser that is in fluid communication with the material vessel to draw solvent from the storage tank into the material vessel and through the biomass material to generate a fluid mixture of solvent and biomass oil that is drawn into the evaporator vessel, or
creating a continuous increased air pressure with the pressure pump in the storage tank to push solvent into the material vessel and through the biomass material in the material vessel to generate a fluid mixture of solvent and biomass oil that is pushed into the evaporator vessel;

extracting the solvent from the fluid mixture in the evaporator vessel by heating the evaporator vessel with the heating source to generate vaporized solvent from the fluid mixture in the evaporator vessel, and returning the vaporized solvent to the storage tank in liquid form by one from among:
drawing the vaporized solvent into the condenser using the continuous reduced air pressure generated by the vacuum pump to condense the vaporized solvent into a liquid solvent, then drawing the liquid solvent into the vacuum tank, shutting off the vacuum pump, and draining the liquid solvent from the vacuum tank into the storage tank or pumping the liquid solvent from the vacuum tank to into the storage tank with a transfer pump;
pushing the vaporized solvent into the condenser using the continuous increased air pressure generated by the pressure pump to condense the vaporized solvent into a liquid solvent, then pushing the liquid solvent into the vacuum tank and thence into the storage tank; and
shutting off the vacuum pump when reduced air pressure was used and allowing the air pressure to increase to atmospheric or greater pressure in the system and push the vaporized solvent to the vacuum tank to be drained into the storage tank.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the following drawings, wherein:

FIG. 1 is a system diagram of an implementation of an essential oil extraction, recovery and purge system in accordance with one implementation of the present disclosure;

FIG. 2 is a cross-sectional view of a material column stand in accordance with the present disclosure;

FIG. 3 is a pictorial view of a kettle used in the system of FIG. 1 in accordance with the present disclosure;

FIG. 4 is a side elevation of the kettle of FIG. 3;

FIG. 5 is a top plan view of the kettle of FIG. 3;

FIG. 6 is a partial, enlarged side elevation view of a bottom of the kettle of FIG. 3;

FIG. 7 is a partial, enlarged cross-sectional view of a wall of the kettle of FIG. 3;

FIG. 8 is a pictorial illustration of a condenser formed in accordance with the present disclosure;

FIG. 9 is a schematic representation of an alternative implementation of the present disclosure showing an enhanced fluid extraction, recovery, and purging system for use with an enhanced method in accordance with the present disclosure in which dual vacuum-pressure closed extraction loops are provided;

FIG. 10 is a pictorial illustration of one implementation of the enhanced fluid extraction, recovery, and purging system of FIG. 9 for use with an enhanced method formed in accordance with the present disclosure in which vacuum only is applied during one phase of a method of operation of the system;

FIG. 11 is a pictorial illustration of the enhanced fluid extraction, recovery, and purging system of FIG. 10 in which pressure only is applied during a another phase of the method of operation of the system;

FIG. 12 is a pictorial illustration of the enhanced fluid extraction, recovery, and purging system of FIG. 10 in which vacuum and pressure are selectively applied during a further phase of the method of operation of the system in accordance with the present disclosure; and

FIGS. 13A-13C illustrate a representative implementation of process steps for methods used with the representative system illustrated in FIGS. 10-12.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures or components or both associated with filters, vacuum pumps, as well as the process of purging solvents from extracted plant oils have not been shown or described in order to avoid unnecessarily obscuring descriptions of the implementations.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation. Furthermore, the particular features, structures, or characteristics may be combined in any suitable manner in one or more implementations.

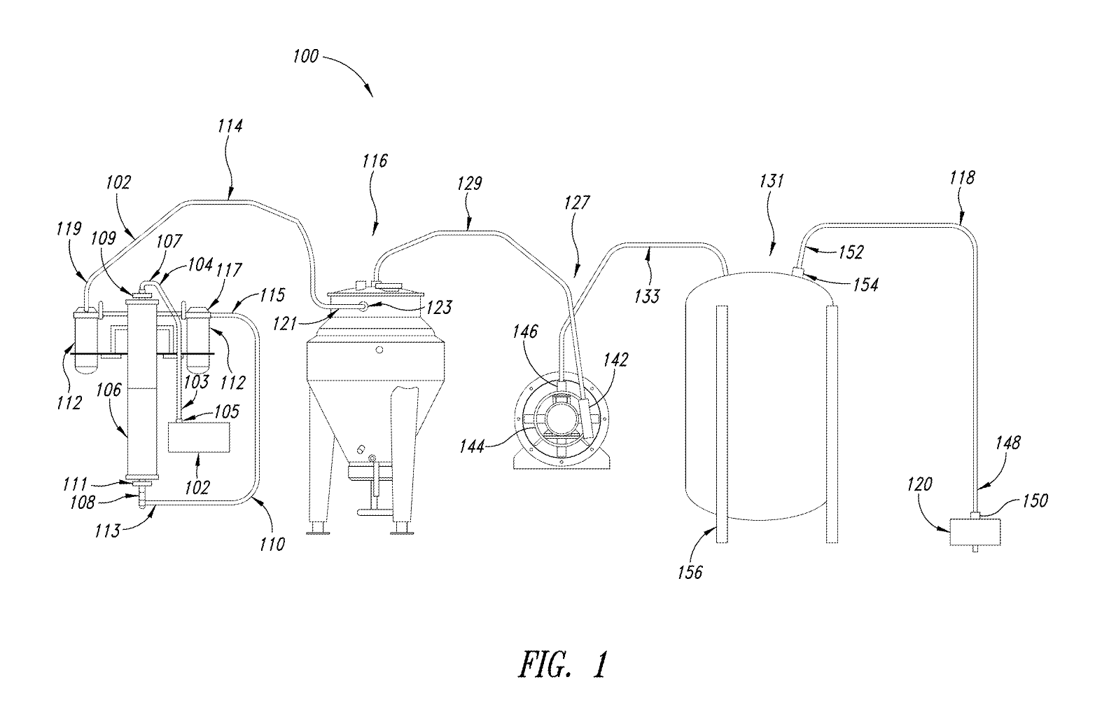

With reference to FIGS. 1-9, shown therein is a system 100 to extract oils, such as essential oils, from plant material and plant-based materials. As described more fully below, the system 100 generally includes a solvent source, a material container structured to contain plant material, the material column in fluid communication with the solvent source, a kettle in fluid communication with the material container, and a vacuum source in fluid communication with the kettle and structured to remove air from within the kettle and pull solvent from the solvent source through plant material in the material column to extract oil from the plant material and move the extracted oil into the kettle.

More particularly, with reference to FIG. 1, shown therein is a representative implementation of the essential oil extraction, recovery, and purge system 100 that includes a solvent source in the form of a solvent chamber 102, a material container in the form of a material column 106 coupled to the solvent chamber 102 with a supply line 104, one or more filters 112 coupled to the column 106 with a first recovery line 110, and at least one kettle 116 coupled to the filter 112 with a second recovery line 114. A condenser 127 is coupled to the kettle 116 via a transfer tube 129 and is capable of condensing solvent vapor recovered from the kettle 116 into a liquid solvent form that is then conveyed to a collection tank 131 via a collection tube 146. The system also utilizes a vacuum source in the form of a vacuum pump 120 coupled to the collection tank 121 via a vacuum line 118.

The solvent chamber 102 preferably has a fluid output, the material container 106 has a fluid input and a fluid output, and the fluid input of the material column 106 is in fluid communication with the fluid output of the solvent chamber 102. The filter 112 has a fluid input and a fluid output, the fluid input of the filter 112 is in fluid communication with the fluid output of the material column 106, and the kettle 116 has a fluid input in fluid communication with the fluid output of the filter 112.

In more detail, the solvent chamber 102 is connected to and in fluid communication with the material column 106 through the supply line 104. A first end 103 of the supply line 104 is connected to a fluid output 105 of the solvent chamber 102, and a second end 107 of the supply line 104 is connected to a fluid input 109 of the material column 106.

The material column 106 is connected to and in fluid communication with the filter 112 through a valve 108 via the first recovery line 110. A second end or output 111 of the material column 106, which is opposite of the fluid input 109 at the first end of the material column 106, is connected to the valve 108. A first end 113 of the first recovery line 110 is connected to a side of the valve 108 opposite of the side that is connected to the second end 111 of the material column 106 such that when the valve 108 is opened, a fluid (i.e., solvent and extracted material, such as essential oil) can flow from the material column 106 to the first recovery line 110. A second end 115 of the first recovery line 110 is connected to a fluid input 117 of one or more filters 112. In accordance with another aspect of the present disclosure, the valve 108 may be located at the top of the material column instead of at the bottom as shown.

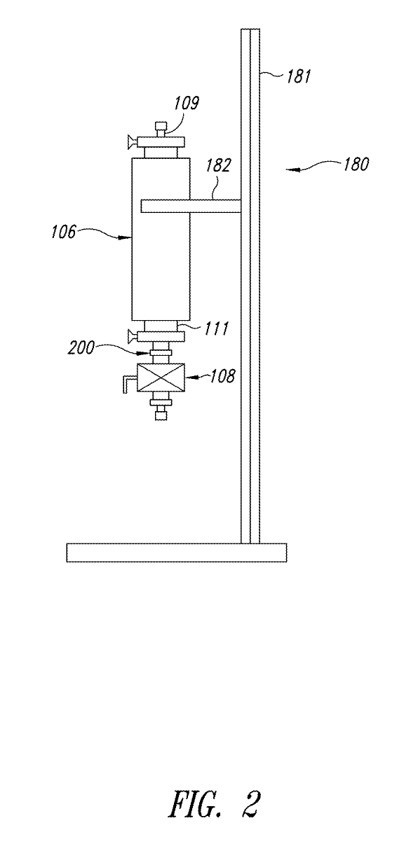

FIG. 2 is a side view of the material column 106 mounted on a material column stand 180 formed in accordance with the present disclosure. In this illustration, the material column 106 is connected to an upright post 181 on the stand 180 by a bracket 182. This mounting configuration maintains an orientation of the material column 106, such that the top 109 of the material column 106 (and the supply line) are positioned above the bottom 111 of the material column 106 (and the valve 108 and first recovery line 110). The bracket 182 may be movably mounted in the stand 180 to enable selective raising and lowering of the material column 106 by a user.

In one implementation, a filter pad 200 is placed between the valve 108 and the second end of the material column 106. In some implementations, the filter pad 200 may be positioned inside and at the bottom of the material column 106. In other implementations, the filter pad 200 may be positioned outside of the material column 106 but between the second end 111 of the material column 106 and the valve 108. In some implementations, a valve assembly may include the filter pad 200 and the valve 108. In at least one implementation, the filter pad 200 is a stainless steel filter pad. The filter pad 200 is readily commercially available and is well known to those skilled in the art and will, therefore, not be described in detail herein. It should be recognized that other filters may be used that restrict material from exiting the material column 106 and entering the first recovery line 110 while allowing fluid (e.g., solvent and essential oils removed from the material) to flow from the material column 106 to the first recovery line 110. Once the filter pad 200 is in position, the valve 108 is connected to the second end 111 of the material column 106. In another implementation, a diffuser or filter is used at the top and bottom of the material column instead of a filter pad.

The filters 112 are connected in series to and in fluid communication with the kettle 116 through the second recovery line 114. A first end 119 of the second recovery line 114 is connected to an output of the filter 112, and a second end 121 of the second recovery line 114 is connected to an input 123 of the kettle 116.

The kettle 116 is also connected to the condenser 127 via the transfer tube 129. The condenser includes a first manifold 142 that receives the vapor solvent from the kettle 116, a coil 144 coupled to the first manifold 142, and a second manifold 146 coupled to the other end of the coil 144. The collection tube 146 conveys the condensed liquid solvent from the condenser 127 to the collection tank 131. The collection tank has a drain with valve on the bottom. It also has a manway at the top for full access if any cleaning or repair is needed.

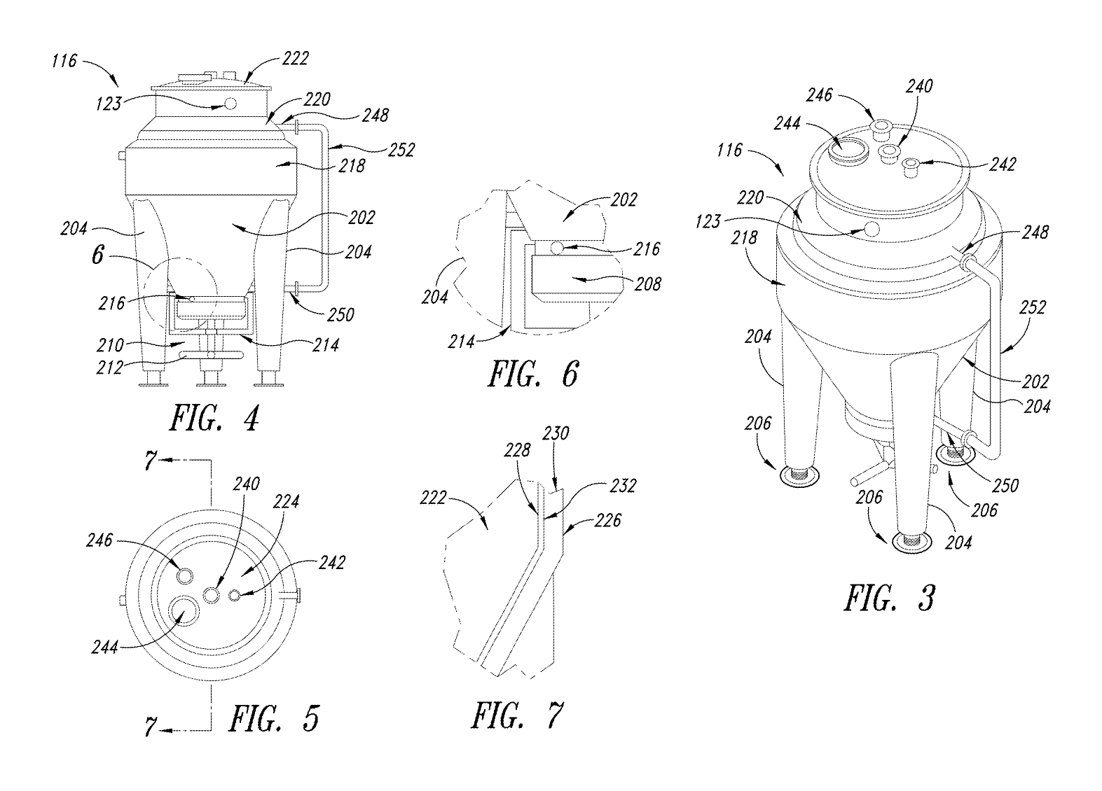

FIGS. 3-7 illustrate the kettle 116 and its construction in greater detail. The kettle 116 is formed in this implementation to have an inverted cone-shaped base 202 from which three legs 204 extend in spaced parallel relationship. A self-leveling foot 206 is at a distal end of each leg 204. The base 202 has an open bottom that opens to a hollow interior of the base 202. Covering the open bottom of the base 202 is a dish 208 held in place by a known clamping mechanism 210, in this case a ball screw and plate 212, 214, which is shown in more detail in the enlarged partial side view of FIG. 6. The ball screw and plate 212, 214 are a well-known clamping system that will not be described in detail herein. The dish 208 is sealed in place with a known gasket or seal arrangement that likewise is known and will not be described in detail herein. To drain the oil from the kettle 116, the ball screw and plate 212, 214, are removed, and the dish 208 is lowered from the bottom of the kettle 16 for emptying, after which it is reattached with the ball screw and plate 212, 214. It is to be understood that other draining mechanisms may be used, including without limitation a simple valve, drain plug, and drain line.

A drain outlet 216 extends from the base 202 and is in fluid communication with the interior of the base 202. This can be used to drain the kettle 116 if needed. In addition, a ball check valve (not shown) can be used to prevent excess fluid from exiting the kettle 116 at any of the output ports. A float switch can also be used in combination with the ball check valve or without the ball check valve that shuts down the kettle heat if the heat level rises above a threshold level. The ball float provides an extra measure of protection in the event the float switch fails. As the liquid rises in the kettle 116, the ball rises inside the housing and blocks the vacuum, thereby preventing any further liquid from being drawn into the kettle 116. A housing for the ball float has holes in a top thereof to allow the vacuum to pull through the system while holes in a bottom of the housing allow liquid in the kettle 116 to raise the ball and ultimately plug the vacuum port when the kettle 116 is full.

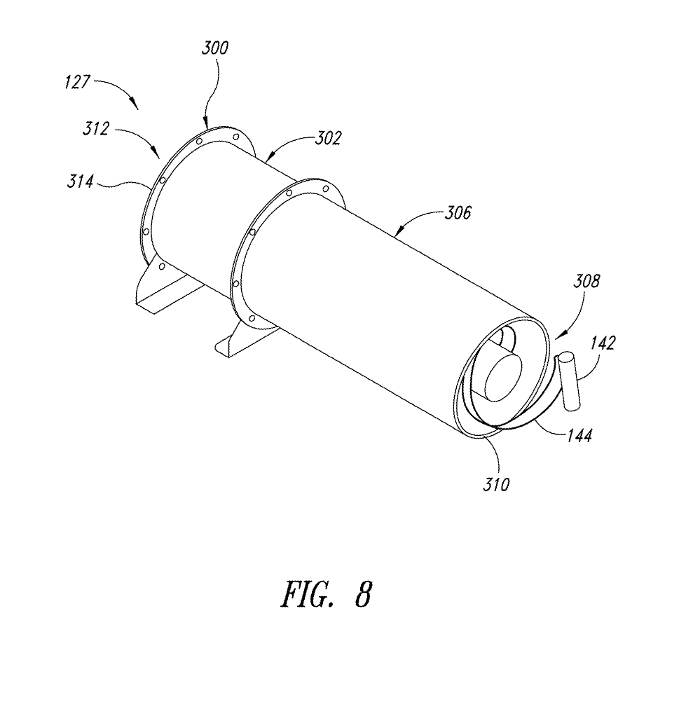

The kettle 116 also includes a cylindrical sidewall 218 integrally formed at the top of the base 202, and a top portion 220 integrally formed with the sidewall 218. The sidewall 218 and the top portion 220 enclose hollow interior space 222 that cooperated with the hollow interior of the base 202 to form an enclosed storage space for the recovered oil and solvent. A cover 224, shown more clearly in the top view of FIG. 5, is removably attached to the top portion 220 to cover a manway that provides access to the interior space 222 for cleaning, etc. In the partial cross section view of FIG. 7 can be seen the internal construction of the base 202, sidewall 218, and top portion 220. An exterior wall 226 and interior wall 228 define a space in which a fluid jacket 230 is defined by a fluid wall 232. Between the jacket wall 232 and the exterior wall 226 is defined an enclosed insulation space 234. The jacket 230 is constructed to carry a heated fluid, such as an oil or steam under pressure to heat the interior space 222 of the kettle 116 and the recovered essential oil and solvent mixture. The heated fluid used to heat the kettle 116 is obtained from a source of heated fluid, such as steam or oil, which is not shown or described herein but is readily commercially available. The heated fluid, for example steam, is conveyed into and out of the jacket 230 through a fluid input port and a fluid output port in the back side of the kettle 116. The heating is done to a temperature in the range of 170 degrees F. to 190 degrees F. and more preferably at about 180 degrees F. to cause the solvent, such as alcohol, to evaporate out of the mixture. The heated fluid supply for the kettle heating is preferably at 5 psi for steam heating. The temperature is changed by lowering or raising the pressure, which is standard boiler operation. Temperature may be monitored by a temperature probe in the dish 208 or a probe near the center of the kettle 116.

On the cover 224 there is an outlet 240 for the alcohol vapor, an alternative vacuum hook up 242 as an alternative to hooking vacuum to the collection tank, and openings 444, 446 that are actually for pressure relief and a gauge, respectively. FIG. 1 shows a first option of having the vacuum pump pulling through the condenser 127 to perform a vacuum distillation. Alternatively, but not as efficient, the vacuum pump 120 is connected directly to the kettle 116 through the port 242 on the right for the fluid extraction. Once the process is finished, the port 242 would be closed and standard distillation would proceed. The vapor would exit through the center port 240 without the assistance of vacuum. It would flow under its own pressure into the collection tank 131.

FIGS. 3 and 4 show two pipes 248, 250 extending out the right side of the kettle 116. A site level 252 in the form of a clear tube connects to the two pipes 248, 250 to provide a visual indicator of the level of fluid in the kettle 116.

In operation, the vacuum from the vacuum pump 120 pulls the extracted oil from the material column 106 into the kettle 116. The extracted oil will include some amount of the liquid alcohol solvent used in the preferred process. By heating the kettle 116 with the steam, the mixture inside in the kettle 116 will heat to a temperature that causes the alcohol to evaporate out of the mixture, leaving the oil to fall to the bottom of the kettle 116 where it is collected by an oil collector, in this case the dish 208. Purging is then done after all the solvent (in the preferred implementation—alcohol) is gone and oil is left in the dish 208. To purge, vacuum is applied to pull out any residual solvent or alcohol that may be trapped in the oil (in other industries this is known as degassing).

Referring next to FIG. 8, the condenser can be a conventional condenser used to reduce solvent vapor to a liquid form or, alternatively, the condenser 127 shown in FIG. 8 can be employed. As illustrated, the condenser 127 has a housing 300 that includes a fan cowling 302, in side which a rotary fan 304 is mounted (seen in FIG. 1), and a condenser housing 306 coupled to the fan cowling 302 and sized and shaped to receive air from the rotary fan 304. An intake opening 308 is formed at a first end 310 of the housing 300 that is suitably screened for protection and filtering. The condenser housing 300 has an exhaust opening 312 to exhaust air from the housing 300 at a second end 314 of the housing 300. Both the fan cowling 302 and the condenser housing 306 have a cylindrical shape with hollow interiors and are formed of solid metal or plastic material to retain the air inside the housing 300 as the air flows from the intake 308 at the first end 310 of the housing 300 to the exhaust opening 312 at the second end 314 of the housing 300

Inside the condenser housing 306 is the condenser tube or coil 144 that is in liquid communication with the kettle 116 via the input manifold 142 and the transfer tube 129 that conveys evaporated solvent vapor from kettle 116. The condenser 127 condenses the vapor to a liquid solvent that is output via the second manifold 146 coupled to an output end of the condenser coil 144. In one implementation, the solvent vapor comes into the condenser 127 through a 2 inch line that is coupled to the first manifold 142. The manifold splits the 2 inch line into 12 lines of ⅜ inch diameter each, which form the coil 144 that extends through the housing 300 to go through the cooling process. At the other end of the housing 300 the 12 lines couple to the second manifold 146 that reduces the 12 lines back into a single 2″ tube 133, which then conveys the liquid solvent to the collection tank 131. The manifold sizes and quantity of ⅜″ cooling lines actually depends on the size of the kettle 116 being evaporated.

Referring once again to FIG. 1, the collection tank 131 is in fluid communication with the vacuum pump 120 via the vacuum line 118. Although not shown, the vacuum pump 120 can include a vapor filter. A first end 148 of the vacuum line 118 connects to an input port 150 of the vacuum pump 120 and a second end 152 of the vacuum line 118 connects to an output port 154 of the kettle 116. The vacuum pump is a conventional, readily commercial vacuum pump and will not be described in detail herein.

The collection tank 131 is essentially a large cylindrical tank having legs to support the tank 131 on a floor or other support structure. A drain (not shown) and manway (not shown) can be provided in the bottom or top of the tank, respectively, or on the side wall of the tank 131 as desired. A ball float or ball check valve (not shown) can be used in controlling the level of liquid solvent in the tank 131 and prevent the liquid entering the vacuum pump. As the liquid rises in the tank 131, the ball rises inside the housing and blocks the vacuum, thereby preventing any further liquid from being drawn into the tank 131. A housing for the ball float has holes in a top thereof to allow the vacuum to pull through the system while holes in a bottom of the housing allow liquid in the tank 131 to raise the ball and ultimately plug the vacuum port when the tank 131 is full. In addition, a float switch can be used in combination with the ball check valve or without the ball check valve that shuts down the kettle heat if the heat level rises above a threshold level.

To understand the basic operation of the system 100 before going into greater detail on the components, the steps for using this system 100 and the resulting process will now be described. Generally, the above-described system 100 is designed to implement a method of extracting essential oils from plant material. The method generally includes the steps of introducing plant material into the material column 106, introducing a cooling liquid into the material column 106, providing a solvent for introduction into the material column 106, creating a vacuum in the kettle 116 that is in fluid communication with the material column 106, and pulling the solvent through the plant material to extract oil from the plant material and pulling the solvent and extracted oil into the kettle 116 with the vacuum from the vacuum pump 120.

Preferably, the plant material in the material container is cooled, either by pre-cooling in a deep freezer or other similar cooling system, or cooled within the system such as with liquid nitrogen, prior to pulling the solvent through the plant material. Additionally or in the alternative, the solvent can be cooled prior to being pulled through the plant material. This cooling of the solvent can be done by deep freezing the solvent or using a cooling liquid, such as liquid nitrogen that is introduced into the solvent container. Alternatively, a jacketed material container, such as a column, can be used with a cooling agent in the jacket to cool material in the material container instead of pouring coolant directly on the material. Ethanol alcohol is recommended as a solvent because it is considered safe for human consumption; however, any solvent that remains liquid under normal atmospheric pressure and temperature maybe appropriate. Isopropyl, hexane, and naphtha are also a commonly used solvent.

The foregoing system is an improvement over the System and Method for Extracting Essential Oils disclosed by the applicant in published PCT application no. PCT/US2016/045422, International Publication Number WO 2017/024072, which is incorporated in its entirety herein by reference.

The present disclosure provides several distinguishing improvements over the prior process and system described in the published PCT application described above. One improvement is the use of the kettle 116. By enabling heating of the recovered mixture of oil and solvent during the extraction process, a more purified oil is obtained. In addition, the solvent is safely and efficiently recovered in liquid form via the condenser 127 and the collection tank 131. This enables separation of the solvent from the oil for large scale extraction operations.

The implementations described above and also herein-below maintain a simple, safe, highly efficient system and process capable of achieving a greater variety of extracted fluids, oils, and compounds in one process that is also scalable on many different levels. Through the disclosed process and equipment, an operator can safely remove and capture the unique compounds that make up a delicate essential oil.

### Alternative Implementation

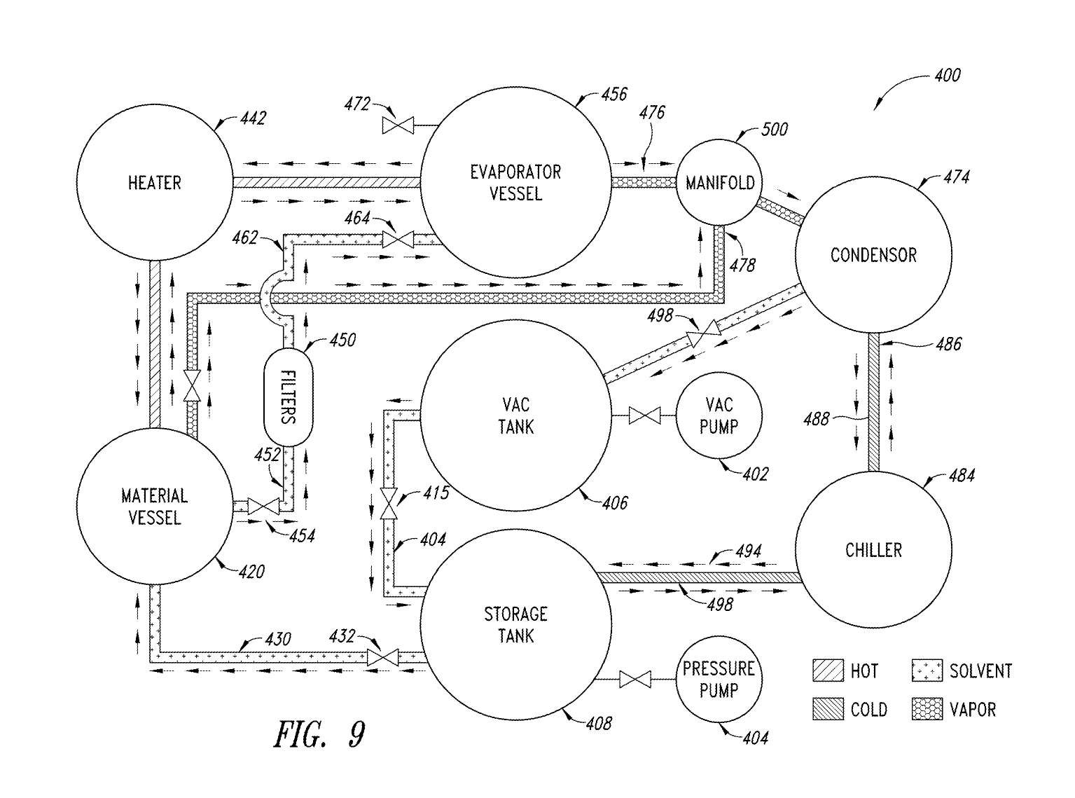

There is currently no one-size-fits-all piece of equipment for extraction of essential oils. There currently exists a water process or steam process or combination water-and-steam extraction process for plants with primarily water soluble constituents. There is CO₂ and distillation for non-water soluble oils, to name a few, most of which can be very complicated and inefficient in extraction and labor requirements. Furthermore, essential oils are very complex and balanced mixtures of hundreds of constituents, each unique in cellular structure and each with a unique purpose. Current standards of extraction do not fully extract many of these important and desirable compounds during the process, and in some cases these extraction process standards cause these compounds to be destroyed. Another problem in current solvent extraction is the loss of solvent which is left saturated in the extracted plant tailings. FIGS. 9-13C illustrate a method for completely drying the plant material after extraction and recovering residual solvent that may be trapped within the plant material after extraction.

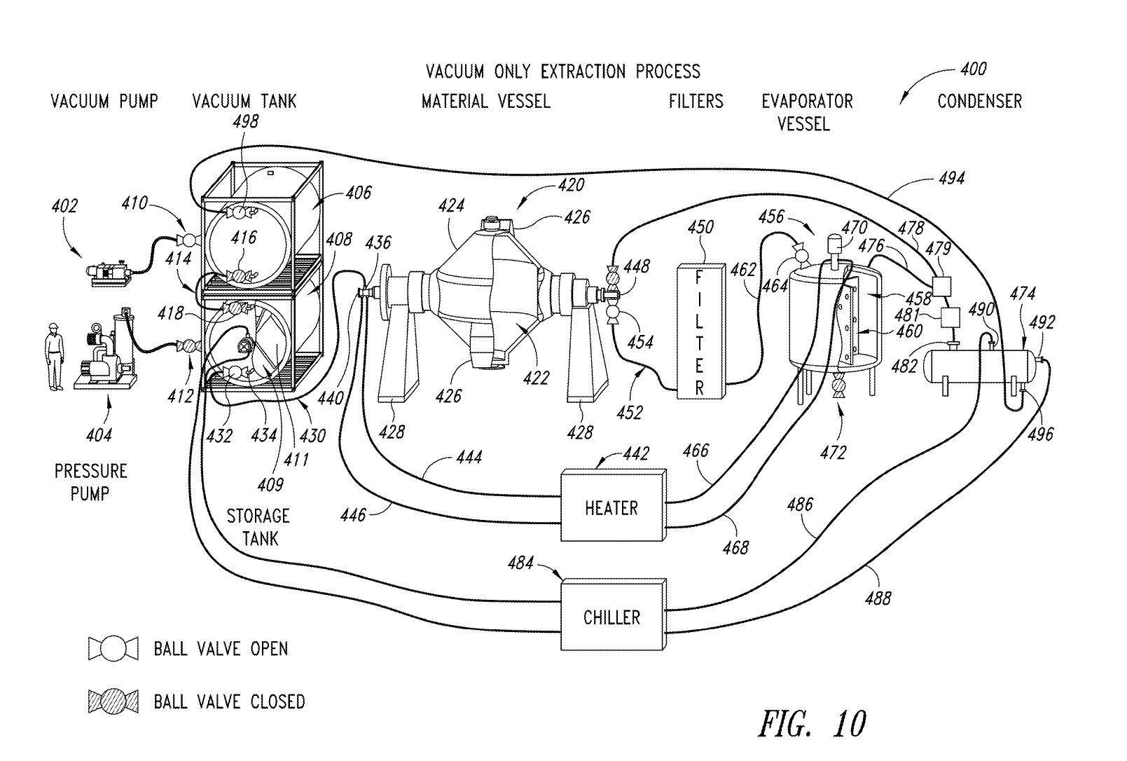

Accordingly, FIGS. 9-13C illustrate alternative implementations of the present disclosure in the form of enhanced systems and related processes for extraction of fluids from biomass material. FIG. 9 is a schematic illustration of an alternative implementation of a system for carrying out a method of extracting fluids from biomass materials that provides for use of vacuum or pressure or a combination thereof with enhanced temperature control to enable extraction of a greater selection of fluids, oils, and compounds. FIGS. 10-12 show a structural implementation of a representative embodiment of a system.

In FIG. 9 is shown a schematic of a unique and effective combination of components enable an operator to select the extraction parameters, such as pressure (including vacuum or negative pressure), liquid or steam and temperature of the main components, to target specific compounds for extraction. Efficiency is achieved on several levels, including structurally, such as using a vacuum tank to retrieve and temporarily store condensed liquid solvent for eventual storage and reuse by a storage tank. These and other features and advantages are provided in the disclosed dual vacuum-pressure closed extraction loop system and related processes, which are described in greater detail below.

In FIGS. 10-12, a representative implementation of an extraction system 400 is illustrated that utilizes dual vacuum-pressure closed extraction loops as well as a steam option based on the schematic shown in FIG. 9. For ease of reference, the reference numbers used in FIGS. 10-12 are shown with their respective functional elements in FIG. 9, but this is not intended to limit FIG. 9 to the implementation shown in FIGS. 10-12. In addition, while a control system is not shown, it is to be understood that various controls may be utilized, both manual and electronic, or a combination thereof, to control the system components, including automated control using a computerized system of sensors, monitors, solenoids, switches, controllers, user interface, and power source for the components and the control system.

The components of the system 400 include a vacuum pump 402 and a pressure pump 404 in fluid communication with a vacuum tank 406 and storage tank 408 via corresponding flow control valves 410, 412, and related fluid communication lines. These two tanks 406, 408 are in turn coupled together for fluid communication via a fluid line 414 and a flow control system 415, such as first and second flow control valves 416, 418 at each end of the fluid line 414. It is to be understood that an alternative arrangement could use a single valve with the single line as shown in FIG. 9.

The storage tank 408 is shown in partial cut-away with an interior chamber 409 exposed to view in which is rotatably mounted a thermal mixing paddle 411, preferably rotated by a motor (not shown) in a conventional manner. The functionality of the thermal mixing paddle 411 will be described more fully below. The storage tank 408 may also have a heating or cooling jacket between the interior chamber 409 and the exterior wall of the storage tank 408.

The thermal mixing paddle 411 for the storage tank 408 is used in the same manner as a thermal mixing paddle 460 in an evaporation vessel 456 described below, except the thermal mixing paddle 411 in the storage tank 408 will cooled instead of heated. It is powered by the motor mounted on either the end or top of the tank 408, depending on the orientation of the thermal paddle 411. The thermal paddle 411 is used to create more surface area for higher efficiency of cooling. Rotating the thermal paddle 411 achieves contact with virtually all the fluid, again achieving results much more efficiently than a simple jacket or stationary cooling chamber. In addition, it is sized and shaped to function similar to a condenser except instead of the fluid moving past the coils, the coils are moving past the fluid.

The heating and cooling liquid that is used to heat and cool the thermal paddle 411 is carried to and from the thermal paddle 411 in a circulatory fashion through a rotary union (such as rotary union 440 described below) mounted between the motor and the tank. The rotary union is constructed of stainless steel and has internal channels to circulate and direct the heating or cooling fluid through and back out to the source of the heating and cooling fluid. Each port in the rotary union has an individual channel through which the fluid runs. Back flow valves can be installed to ensure separation of all fluids entering through the rotary union. The thermal paddle 411 rotates in the range of 1 to 100 rpm and preferably in the range of 5 to 20 rpm, and more preferably about 10 rpm.

The thermal paddle 411 is constructed in a manner to achieve as much surface area as possible while allowing it to pass through liquid, such as solvent, without significant resistance. Ideally the thermal mixing paddle will be constructed of stainless steel and have internal channels to circulate and direct the heating or cooling fluid through and back out to the source. The thermal paddle in the storage tank 408 will operate as soon as fluid is introduced into the storage tank 408 and continue operation until extraction is complete.

In one aspect of the present disclosure, heat is added to the jacket of the storage tank 408 and the paddle 411. This would be useful, for example, when extracting cinnamon oil because it would be advantageous to extract the cinnamon oil with hot solvent instead of cold.

A material vessel 420 is utilized to hold the biomass material in the interior 422 of a chamber 424. The biomass material is introduced into the chamber 424 via a first load/unload port 426, shown at the lower end of the chamber 424 with a second load/unload port 427 at the opposing upper end of the chamber 424. In one implementation the chamber 424 is rotatably mounted to a pair of stands 428, which are located at the lateral ends of the chamber 424, to enable spinning or rotation of the chamber 424 about a horizontal longitudinal axis of the chamber 424.

A solvent supply line 430 couples the chamber 424 to the storage tank 408 for flow of solvent in fluid form from the storage tank 408 into the chamber 424, and a flow control valve 432, which is located at a port 434 on the storage tank 408 and to which a first end of the solvent supply line 430 is coupled, controls the flow of the solvent from the solvent storage tank into the chamber 424. The other end of the solvent supply line 430 is coupled to a coupling port 436 on the material vessel 420 to be in fluid communication with the interior 422 of the chamber 424. Ideally the coupling port 436 is part of a first rotary union 440, which is well known in the art and readily commercially available. Briefly, the first rotary union 440 enables the connection of one or more fluid lines to be connected at a stationary or fixed position while permitting an attached vessel to rotate. Fluid can flow through the fluid line, the rotary union, and into the interior of the vessel when the vessel is stationary and rotating.

In this implementation a heater 442 has first and second fluid lines 444, 446 also coupled to the first rotary union 440, which will be described in more detail herein below. The material vessel 420 also includes a second rotary union 448 on an opposite side of the material vessel 420 than the first rotary union 440. A filter system 450 that includes one or more filters (not shown) has a fluid input line 452 with a first end coupled to the second rotary union 448 via a flow control valve 454 and a second end coupled to the filter system 450.

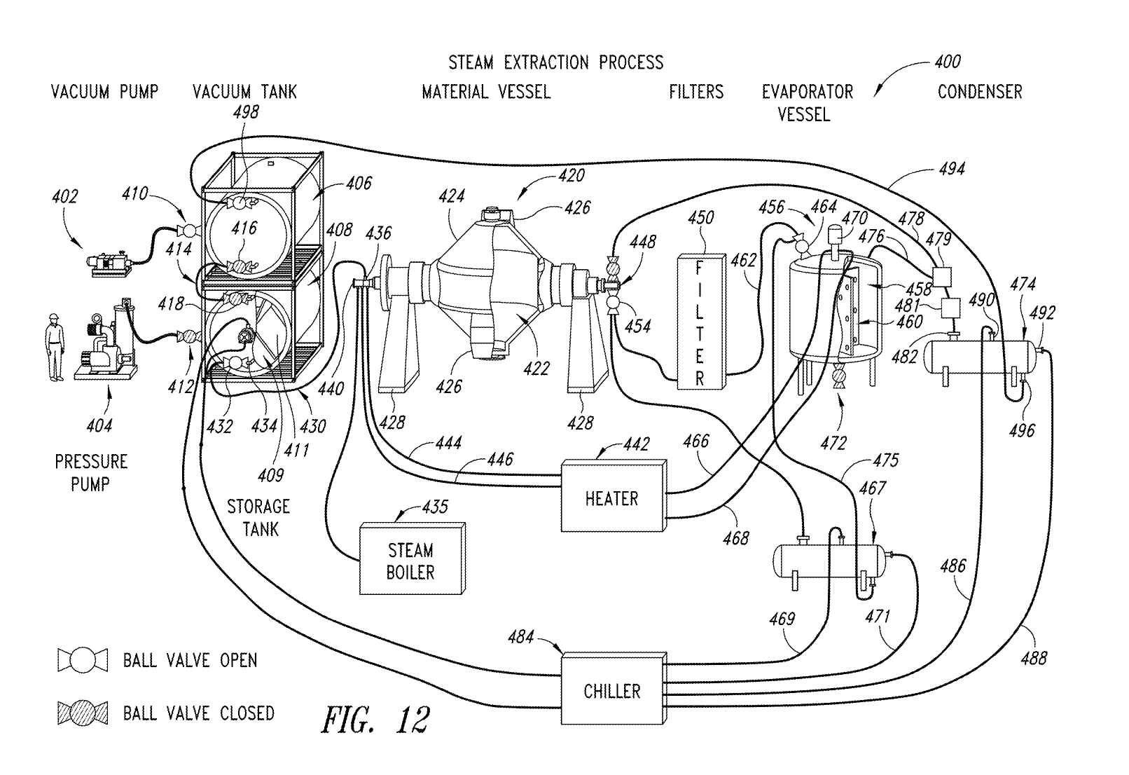

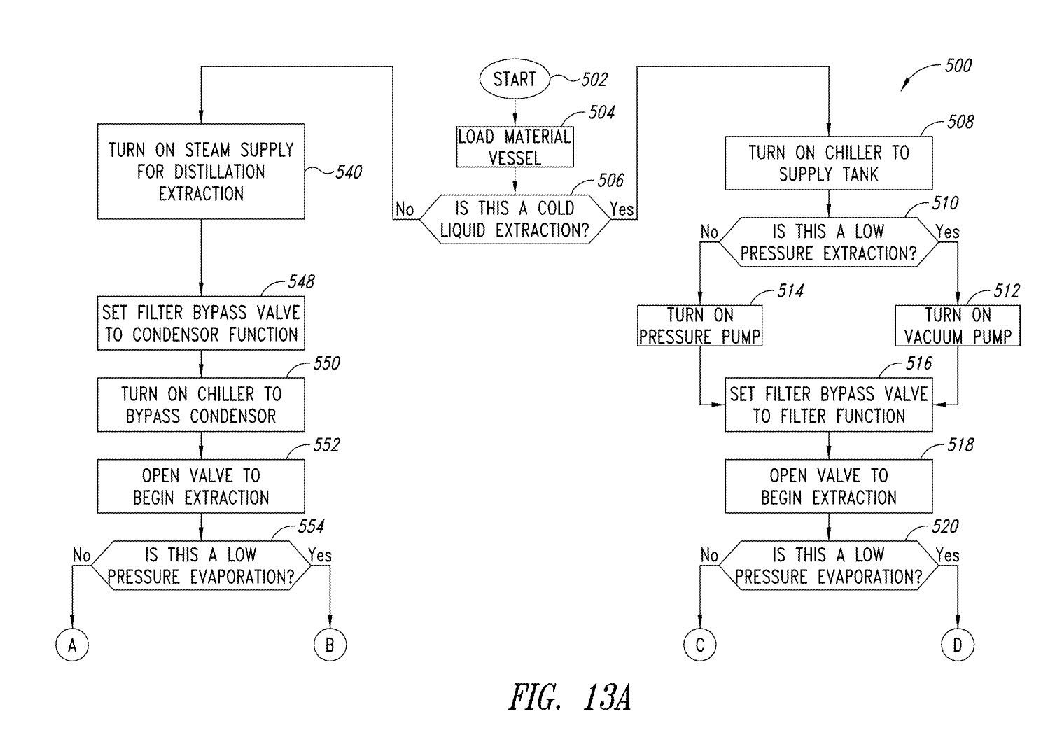

In another aspect of the present disclosure, an alternative to vacuum or pressure is a steam boiler 435 (shown in FIG. 12) that will provide heated steam directly to the material vessel 420 through a steam line connected to the rotary union 436. An implementation of this option is described below in the operation of the system 400.

An evaporator vessel 456 is provided that includes an interior chamber 458 with thermal mixing paddle 460 in a vertical orientation mounted therein. A fluid input line 462 is in selective fluid communication with the interior chamber 458 via a flow control valve 464 at a first end and is further coupled at a second end to the filter system 450. The heater 442 has third and fourth lines 466, 468 coupled for fluid communication with the interior chamber 458 at a common rotary union input port 470. At the lowest point of the evaporator vessel is a fluid collection and discharge valve 472 that enables selective draining of extracted fluid from the interior chamber 458.

The system 400 further includes an evaporator condenser 474 that collects vaporized solvent from the evaporator vessel 456 by way of fluid line 476 and condenses it to a liquid. Vapor is also collected from the material vessel 420 at the second rotary union 448 via a fluid line 478 and flow control valve 480. As shown in this implementation, the two fluid lines 476 and 478 join together, either at a Y coupling or at an input port 482 on the evaporator condenser 474. In one implementation a manifold 479 is used for connection of the two fluid lines 476, 478 going into the input port 482 of the evaporator condenser 474.

A chiller 284 is utilized to provide chilled fluid via fluid flow line 486 to the evaporator condenser 474 and to return heated fluid via fluid flow line 488 at respective ports 490, 492. The chiller 484 aids in the condensation process of the evaporator condenser 474 as described more fully below. A further fluid line 494 has a first end coupled to the evaporator condenser 474 at port 496 and a second end coupled to the vacuum tank 406 via a flow control valve 498.

### Operation and Process Steps

FIG. 10 illustrates the system 400 configured for vacuum-only extraction of fluids from biomass material. In particular valve 410 from the vacuum pump 402 is open while valve 412 from the pressure pump 404 is closed. Also, the valve 448 between the material vessel 420 and the manifold 479 is closed while the valve 454 between the material vessel 420 and the manifold 479 is open, and is the valve 464 between the filter system 450 and the evaporator vessel 456. In addition, the two valves 416, 418 between the vacuum tank 406 and the storage tank 408 are both closed.

Initially, the storage tank 408 is filled with solvent. When so filled, the storage tank 408 functions as a supply tank (referred to throughout as either the storage tank 408 or supply tank 408) to supply the solvent to the material vessel 420 via the solvent supply line 430 and as controlled by the flow control valve 432. When it is desired to transfer recovered solvent from the vacuum tank 406 into the storage tank 408, the two valves 416, 418 are opened and the vacuum pressure on vacuum tank 406 is released or, if under vacuum, is pumped to storage tank 408. It is to be understood that a single valve could also be used in place of the two valves 416, 418.

The self-loading material vessel 420 is filled with biomass material. Filling may be accomplished manually (when the opening is in the upward position) and emptying by gravity (when the opening is in the downward position) or commercially available vessels may be used that permit semi-automatic or automatic loading and unloading of the material vessel 420.

Once the biomass material is loaded into the material vessel 420, the solvent can be moved into the interior chamber 422 of the material vessel 420 in several ways.

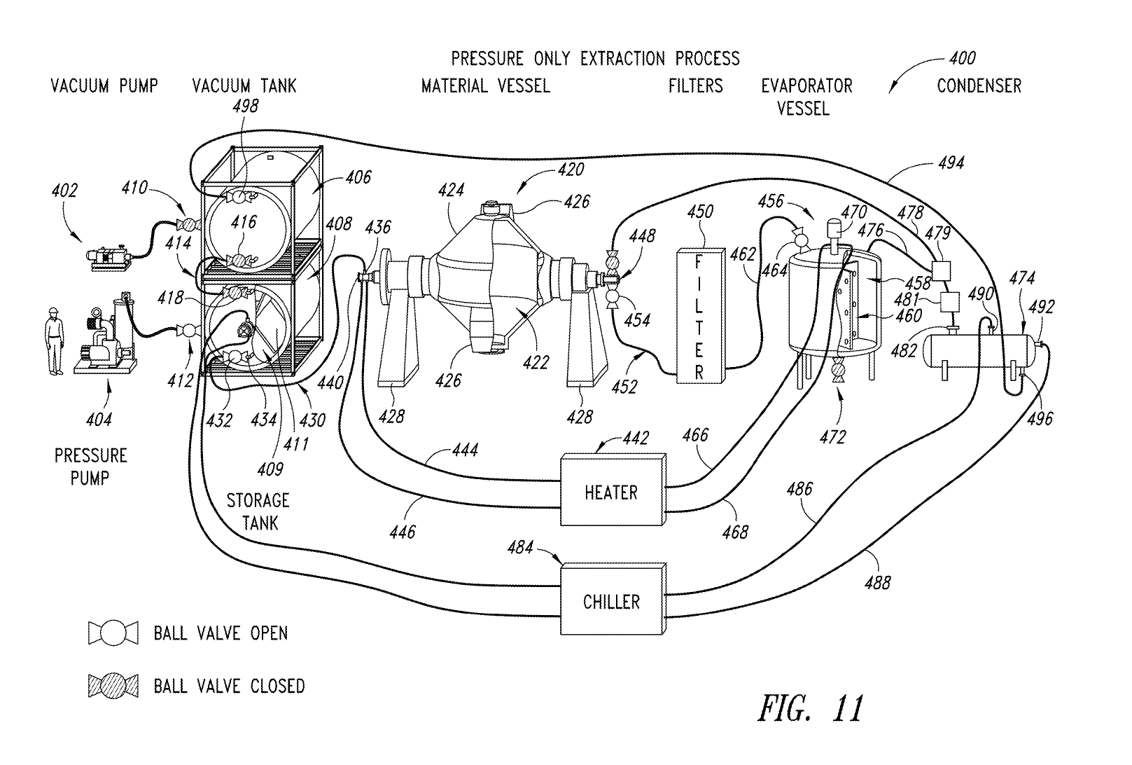

Pressure can be applied in some cases where ultrafiltration, such as membrane and reverse osmosis, is desired. As shown in FIG. 11, with the valves 410, 416, 418 for the vacuum pump 402 and vacuum tank in connection with supply tank 408 closed, pressure is applied to the supply tank 408 from the pressure pump 404 via open flow control valve 412, up to 150 psi, depending on varied filtration specifications, to push solvent through the material vessel 420, into the filter system 450 via open valves 454 and 464, and into the evaporator vessel 456. An interior level measuring and control device (not shown) regulates liquid volume in the evaporator vessel 456, preventing overfilling. There is also a pressure regulator and relief valve (not shown) to prevent over pressurizing of the system 400.

However, in a preferred method of solvent transfer, vacuum is used due to achieve greater safety and lower cost. Initially, the valves 416, 418 between the vacuum tank 406 and the supply tank 408 are closed (meaning no fluid will flow). The vacuum pump 402 is activated, thereby reducing pressure in the system 400 to create a vacuum that pulls solvent from the supply tank 408 via the valve 432, through the material vessel 220, through the filter system 450 via the output valve 454, and into the evaporator vessel 456 via the input valve 464. A vacuum relief valve on the supply tank 408 will actuate while the vacuum pump 406 is on, allowing atmospheric air or connected inert gas into the supply tank 408, which allows solvent to be pulled out of the supply tank 408 by the vacuum pump 402. The vacuum pump 402 continues drawing air into the supply tank 408 by pulling the solvent out. During this process vacuum or negative pressure can be determined by one of skill in this technology depending on factors such as the size of the system, the diameter of the fluid lines, and pump capacity. Ideally the vacuum can range from 29.92 inch Hg (1 Atm) down to 0.5 inch Hg depending on the level of atmosphere air or inert gas being drawn into the system 400 and the flow rate of the solvent running through the system. The size of the vacuum pump 402 as well as flow rates will vary depending on the scale of the system 400.

In a preferred implementation of the method, it is be desirable to chill solvent to subzero temperatures prior to pulling or pushing it through the biomass. This can be achieved by chilling the supply tank 408 and the solvent in the interior chamber 409 by means a jacket on the supply tank 408 and the interior mixing apparatus or thermal mixing paddle 411 (similar to a method used in heating the evaporation vessel 456) or attaching an additional common heat exchanger with fluid connection between the supply tank 408 and the material vessel 456.

Once the proper amount of solvent has been run through the biomass material in the material vessel 420 and then drawn into the evaporator vessel 456 with the extracted fluid, the valve 454 is closed between the material vessel 420 and the filter system 450, and the valve 464 between the filter system 450 and the evaporator vessel 456 is also closed, thus isolating the filter system 450. Heat is then applied to the jacket in the material vessel 420. The material vessel 420 will begin rotation with attached stationary lines in place by means of the rotary unions 436, 448 on each end. The rotation may be done manually, but in a preferred implementation an electro-mechanical system may be used to rotate the material vessel 420, which will not be described in detail herein because such rotation systems are well known in the art and readily commercially available. This rotation will help to evenly dry and remove residual solvent from the saturated biomass. Drying the biomass is desirable for safe disposal.

The paddle in the evaporation vessel 456 will begin rotation as soon as the extraction process begins and fluid begins entering. It will have a very thin scraper on the bottom (common on mixers) which will be at the appropriate angle to direct the concentrated oil to the center of the vessel while simultaneously spreading it around. It is desirable to continually spread and mix the oil to facilitate evaporation of any remaining trapped solvent as well as keep the temperature even throughout the product.

Heat is simultaneously applied to a jacket on the evaporation vessel 456 as well as to an interior of the thermal mixing paddle 460 from the heater 442 by means of the two lines 466, 468 and the rotary union input port 470. Solvent in the evaporation vessel 456 will be evaporated in response to the heat from the evaporation vessel 456 and the paddle 460, leaving (aside from the solvent vapor) the extracted fluid, such as essential oil, to collect in the bottom and be drained by means of the drain valve 472.

If the vacuum tank 406 is under vacuum and the storage tank 408 is at atmospheric pressure, a pump (not shown) between the two tanks 406, 408 can be used, which would be controlled by a level switch inside the storage tank 408.

The evaporation phase can be done one of two ways as described below and can range in temperature from 60 degrees F. up to 180 degrees F. depending on the desired results.

The process of essential oil production is dependent on the oil to be obtained. With essential oils, each one has different constituents, each with different boiling points and chemical make ups. Changes in process temperature or pressure can convert compounds and even change the polarity. Isomerization is common and can be desirable for some oils. Because of these variables, each extraction process is specific to a desired compound. There is no one right way to accomplish an extraction, and it is in many ways dependent on the extraction artist, which is why there are numerous methods. The systems disclosed herein give the extraction artists as many options to achieve whatever results they are seeking.

For example, one of the most common ways commercial essential oil is extracted is by distillation. The problem with distillation is that it relies on boiling points, and many heavier compounds will not come through. With the disclosed liquid extraction processes and systems with simple evaporation and a wide range of available temperatures and pressures, virtually all compounds can be extracted, thus providing a more complete list of products or ingredients from which to create their specific version or secret recipe. Cold extraction and filtration enable the removal of organic matter and plant waxes that would otherwise require distillation to remove.

The different pressures accommodate the different boiling points of the various compounds. In some oils there are compounds that do not tolerate heat while evaporation requires it. By reducing pressure, an operator is able to satisfy both requirements of heat and boiling points. In other words, reducing pressure will reduce the boiling point, thus reducing the amount of heat required. As such, a different compound can be obtained than would normally be produced at higher pressures and temperatures.

### Example of Ranges:

| Oil | Boiling point | Molecular weight |
|---|---|---|
| Peppermint | 408 F. | 965 |
| Cinnamon | 478 F. | 282 |
| Lavender | 167 F. | 126 |

As can be seen, there is a wide range among these common oils. The molecular weight is as important as the boiling point and the extraction temperature. For instance Cinnamon does not have as much chlorophyll and waxes as Lavender, which will require higher extraction temperatures. Cinnamon has a low molecular weight, in which case evaporating at lower pressures may be more desirable that what is used with Peppermint. Lavender has both low boiling points and low molecular weight, which requires low temperature and low pressure throughout the entire process.

Examples of pressure ranges include 0 PSI to and including 150 PSI, and the vacuum range is from 0.5 in·Hg to and including 0. Hence, the effective operating range is from 0.5 in·Hg vacuum (−0.245577 PSI) to and including +150 PSI.

Also illustrated in FIGS. 10-12 is a molecular filter, preferably a molecular sieve 481, that is structured to remove water and contaminates from the solvent, such as ethanol, during evaporation of the residual solvent in the material vessel. This is a passive device, meaning it does not need to be turned off or on, similar to the filters in the filter system 450. There are no valves, only a connection to the fluid line 478 going in and out of the sleeve 481. More particularly, the sieve 481 has a pore size in the range of 3 Å to 10 Å, depending on the target, but typically it is 3 Å to remove water. The sieve 481 includes an input coupled to an output of the material vessel 420 and an output coupled to an input of the evaporator condenser 474. Ideally, the sieve 481 can have its input also coupled to an output of the evaporator vessel. Anytime the material vessel 420 is heated during the evaporation process, the molecular sleeve 481 is in use. Molecular sieves are readily commercially available and will not be described in more detail herein.

Briefly, during extraction solvents will become diluted with water or moisture that is in the biomass. Because the solvent is used repeatedly, it becomes increasingly diluted and, hence, less effective in extracting. Standard distillation processes will not efficiently remove water below 5% nor does distillation remove fine contaminants. An inline molecular sieve will remove water down to 0.5% as well as remove other fine molecules that contaminate the solvent.

In a first evaporation method, which uses the system configuration shown in FIG. 12, by opening the valve 410 to the vacuum tank 406 and the valve 498 and 496 to the evaporator condenser 474, and then turning on the vacuum pump 402, heated vapor from the material vessel 420, through open valve 454 into the filter system 450, through open valve 456 into the evaporator vessel 456, and then it is pulled into the common manifold 479 and through the evaporator condenser 474, which condenses the solvent vapor to liquid solvent. The condensed liquid solvent is then collected in the vacuum tank 406 via the fluid line 494. This can be done at any level of vacuum by use of a regulator (not shown) depending on the desired end product. The selection of a regulator will be within the ability of one of ordinary skill in this technology.

It is noted that fluids from plants, particularly essential oils, contain hundreds if not thousands of constituents—each with different boiling points and values. By reducing pressure and heat to different levels and combinations, many different types of fluids can be realized. This flexibility is very desirable for extracting different compounds from different types of biomass as well as creating different end products from the same biomass.

In a second evaporation method, with the vacuum pump 402 turned off, atmospheric pressure can be relied upon to heat the solvent vapor, which will expand, pushing itself without assistance through the condenser and into the vacuum tank 406, which functions as a collection tank at this stage. The disclosed system can achieve ambient or atmospheric pressure in the evaporator vessel 456 by simply turning off the vacuum pump and allowing the boiling solvent to create pressure by means of the expanding vapor. No valves need to be changed from the normal operation of evaporation. The chilling of the vapor will also create a vacuum effect, assisting in movement of the solvent vapor in sequence from the material vessel 420 to the filter assembly 450, the evaporation vessel 456, the evaporator condenser 474, and then to the vacuum tank 406. In one aspect, the evaporator condenser 474 is mounted above the tank 406 or a pump is used to transfer liquid from the evaporator condenser 474 into the tank 406. On the other hand, solvent will always move either by vacuum or pressure from the tanks into the material vessel.

It is to be understood that another variation for the system 400 includes the possibility of using pressure as a third evaporation method. If distillation under pressure is desired, then the venting of tank 406 is controlled using a pressure regulator, and the evaporator is heated at a rate to allow the pressure to build in the evaporator. In this implementation, the pump 404 is not needed. In yet a third method using pressure, however no pump is needed. There would need to be a valve between the evaporation vessel 456 and the pump that would remain closed during all other operations.

Continuing with the current description, heated vapor will flow through the manifold 479 to the common evaporator condenser 474, which is also connected to the chiller 484. Once the evaporation process is complete, liquid solvent that is collected in the vacuum tank 406 can be drained into the storage tank 408, either by gravity through the valves 416, 418, or a single valve if preferred, when mounted in a stacked position as shown (preferred) or with the use of a pump if mounted horizontally or when located in different locations, which may be required depending on facility restrictions. If a force is required to move the liquid solvent to the storage tank 408, the preferred method will be the use of vacuum pump. This can be achieved, for example, by attaching a vacuum pump line to the supply tank and opening the relief valve (not shown) on the vacuum tank. This will cause the solvent to be pulled from the vacuum tank 406 to the storage tank 408 in a safe manner.

Equipment operation can be automated and controlled by use of a control system that employs automation software, or it can be manually operated, depending on the user's specifications. It is expected that one of skill in this technology can develop a computer implemented control program with appropriate wiring, solenoids, and sensors, to operate the enhanced system 400 in accordance with the method and processes described herein.

It is noted that by using different levels of pressure and vacuum, a wide range of temperatures can be achieved, allowing for variations in product quality and features, as desired.

It is also noted that the liquid solvent can be chilled prior to flow through the biomass by the use of an outside chiller with thermal jackets on the vessels

And it is further noted that although vacuum is the preferred method of each process there may be applications in which pressure becomes necessary such as using a higher level of filtration in which vacuum is not powerful enough to achieve solvent and extracted fluid pull through.

Also shown in FIG. 12 is a bypass condenser 467 coupled to the chiller 484 with first and second fluid lines 469, 471, and also coupled to the valve 454 on the material vessel 420 via fluid line 473 and to the valve 464 on the evaporator vessel 456 via fluid line 475. The bypass condenser 467 is used for steam extraction. During steam extraction the valve 448 is in the closed position and the two valves 454 and 464 are each set to bypass condenser function. Steam produced by the steam boiler 435 enters the material vessel 420 through the rotary union 436. Steam and extracted oils flow through the bypass condenser 467 and into evaporator vessel 456

In some cases where ultrafiltration is desired, such as with a membrane and where reverse osmosis is desired, it may be necessary to use a certain amount of applied pressure. With the valve 410 to the vacuum pump 402 closed and the vacuum tank valves 416, 418 in connection with supply tank 408 closed, pressure is applied to the supply tank 408 from the pressure pump 404 via the flow control valve 412, which can be up to 150 psi, depending on varied filtration specifications, to push solvent through the material vessel 420 into the filter system 450 and into the evaporator vessel 456. An interior ball float (not shown) or other standard level regulator regulates liquid solvent volume in the evaporator vessel 456 to prevent overfilling. There is also a pressure regulator and relief valve to prevent over pressurizing of the system.

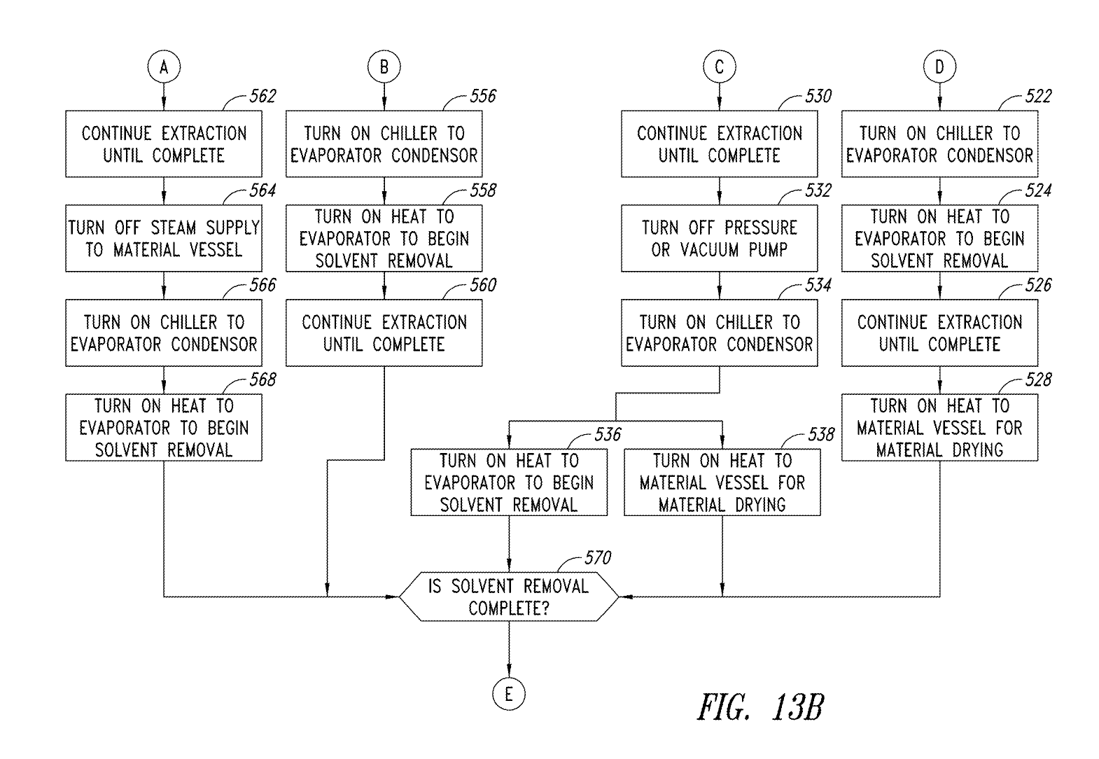

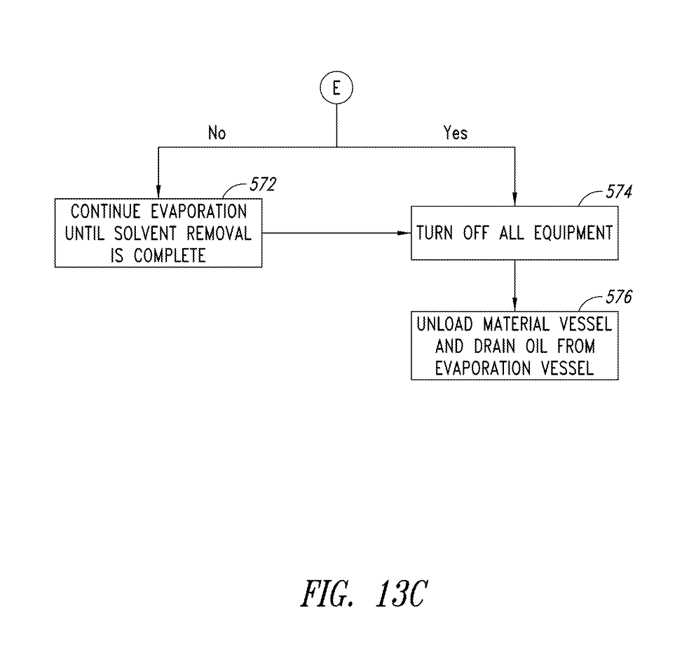

Turning next to FIGS. 13A-13C, illustrated therein is a flowchart for the processes 500 described above. This is not a step-by-step illustration of every aspect of the processes. Rather, FIGS. 13A-13C illustrate the basic decisions and actions for configuring and using the systems illustrated in FIGS. 9-12.

At the initial start 502, the material vessel 420 is loaded with biomass material 504. At decision box 506 the operator determines if this is a cold liquid extraction. If yes, the process branches to the right, if not, it branches to the left as shown in FIG. 13A.

Looking first step 508 of the cold liquid extraction method, the operator turns on the chiller 484 to the supply tank 408 after ensuring sufficient liquid solvent is in the tank 408. The amount of solvent will in most cases depend on the type and quantity of biomass material being processed.

At decision point 510 the operator determines if this is a low pressure extraction. If so, the vacuum pump 402 is turned on 512, and if not, the pressure pump 404 is turned on 514, and the respective valves 410, 412 at the output of each pump are opened or closed as needed and as described above. A filter bypass valve is then set to “Filter Function” 516. The filter bypass valve is valve 454, which can be a common 3-way valve that is open flow to the material vessel but can either be turned to the condenser or the filters, but never both at the same time. The valve 454 is then opened 518 to begin extraction 524, which continues until complete 526.

The operate then determines at decision point 520 if this is a low pressure evaporation method. If yes, the process follows path D to FIG. 13B, where the operator turns on the chiller 484 to the evaporator condenser 474 (step 522), turns on heat from the heater 442 to the evaporator vessel 456 to begin solvent removal (step 524), and allows the process to continue until complete 526. Following completion, the operator turns on the heat to the material vessel 420 for material drying 528.

If at decision point 510 the operator determines it is not a low pressure evaporation, the process proceeds along path C. Extraction continues until complete 530, after which the pressure or vacuum pumps 402, 404 are turned off 532 and the chiller 484 is turned on 534 for the evaporator condenser 474. The operator then turns on heat 536 to the evaporator vessel 456 to begin solvent removal while simultaneously applying heat 538 from the heater 442 to the material vessel 420 to begin drying of the processed biomass material.

Returning to the initial decision point 506 of cold liquid extraction, if the operator determines it is not cold liquid extraction, the operator turns on the steam boiler 435 for steam extraction. The steam extraction process continues with the filter bypass valve 454 set to condenser function 548. The chiller 484 is turned on 550 and the valves configured to connect to the bypass condenser 467, and the valve 454 is opened to begin extraction 552.

The operator then determines at decision point 554 if this is low pressure evaporation, and if so the process follows path B to FIG. 13D. The operator turns on the chiller 484 to the evaporator condenser 474 (step 556), turns on heat from the heater 442 to the evaporator vessel 456 to begin solvent removal (step 558), and allows the process to continue until complete 560.

If at decision point 554 the operator determines it is not a low pressure evaporation, the process proceeds along path A. Extraction continues until complete 562, after which the pressure or vacuum pumps 402, 404 are turned off 564 and the chiller 484 is turned on 566 for the evaporator condenser 474. The operator then turns on heat 568 to the evaporator vessel 456 to begin solvent removal.

The operator then determines if the solvent removal is complete (570). If not, the evaporation continues until the solvent removal is complete 572. If it is complete, the equipment is turned off or otherwise deactivated 574 and the material vessel 420 is emptied of the biomass material that remains therein and the extracted fluid, such as oil, is drained from the evaporation vessel 456 in step 576.

The above-described enhanced system and method provide numerous advantages, including without limitation:

1. Use of Low Pressure
a. Low pressure (vacuum) is advantageous when working with flammable solvents. By creating a vacuum within the system, any potential leaks will draw atmosphere into the system rather than allowing flammable material out.
b. Low pressure (vacuum) is also advantageous in the extraction process. By gently saturating and continually flowing solvent through the biomass, the fluids such as essential oils are gently washed away and more of the compounds are preserved in their natural state. Extraction under high pressures or agitation or both can damage—and in cases of supercritical extraction—destroy or chemically alter certain compounds.
c. Low pressure (vacuum) is also advantageous in the extraction efficiency. By not only continuously or continually pulling with vacuum from the vacuum pump, but also introducing ambient air or supplied air to the supply tank via a check valve on the tank, which allows air in but not out, a type of pushing effect is achieved without added pressure. New atmosphere is continually pushing fluid while removed atmosphere is pulling. This allows for a very gentle, continual flow of solvent. This is important in extraction efficiency because high pressure systems are forceful in nature and can cause channeling through the material, i.e., when the fluid takes the more direct path of least resistance through the material, bypassing some material and leaving behind much of the product intended to be removed.

2. Use of Low Temperature
a. Much like low pressure, low temperature extraction and evaporation preserves more of the constituents than methods that use heat during extraction such as distillation. Because each of the compounds that make up an essential oil have different boiling points, it is advantageous to operate at low temperatures in order to prevent unnecessary evaporation and retention, each leading to some or complete loss of these compounds in the finished oil.
b. Low temperatures also cause coagulation of many unwanted plant waxes. By coagulating these waxes, they can then be filtered. At higher temperatures these waxes would simply dissolve and be carried through to the finished oil. In some cases these waxes may be desirable. In this case operating without the chiller, it is an option.

3. Filtration
a. Through filtration we are able to selectively remove unwanted contaminants in flow, such as the plant waxes described above as an example. By contrast other methods and equipment require fractional distillation or additional purification processes to separate. Other even more complex methods require selective extraction using multiple layered solvents or selective solvents. By mechanically removing contaminates with filtration rather than chemically, as is the case with fractional distillation and layered solvents, more of the many compounds are preserved.

4. Flexibility
a. The ability to change temperature and boiling points through various pressures allowing different results when desired
b. The ability to change extraction temperatures with the use of a chiller, thermal mixers and jackets
c. The ability to simply alter filtration types and media while maintaining the same process without changes to the equipment for different results.

5. Efficiency
a. Although difficult to show in schematics and descriptions, the method and equipment described has proven to be highly efficient in extracting all extractable compounds as well as reducing labor and operating costs.
b. Also referred to above in connection with the use of low pressure.

6. Drying of Tailings
a. Removal and recapture of residual solvent from extracted biomass without exposing it to the environment, creating a safe and non-explosive work environment is very advantageous.
b. Removal of residual solvent also eliminates the need for further processing of extracted tailings or additional safety equipment such as explosion proof exhaust fans or rooms.
c. Removal and recapture of residual solvent from extracted biomass reduces the loss of solvent, which is inherent in other ethanol extraction methods.

7. Thermal Mixing Devices within Tanks.
a. By utilizing a thermal mixing device within the vessels, energy consumption is reduced in maintaining desired temperatures.
b. Essential oils are very sensitive, and by utilizing a thermal mixing device in the evaporation and collection vessel more temperature controlled surface area is created, which also allows for more precise and controlled temperatures, thus preserving the many different compounds of the oils within. For comparison, many other processes require surfaces to be “overheated” past the desired product temperature to achieve product temperature requirements.
c. The thermal mixing device also allows for lower temperature evaporation of residual solvents that may be trapped within the oil. By continually mixing and heating at the same time, viscous oils are “churned” with the heated device creating a “thin film evaporation” effect. Thin film evaporation is a common method of solvent evaporation that typically requires specialized equipment in which solvent is introduced in a thin film across a heated surface. The present disclosure achieves a similar effect with the thermal mixing paddle. And the system of the present disclosure is able to cool more effectively in a similar manner within cold supply and storage tanks.

### Improvements and Modifications Provided by the Enhanced System and Process

1. Created a closed loop by connecting a supply tank to the vacuum tank
2. Added a biomass post extraction drying process.
3. Created a new scalable self-loading material vessel
4. Added thermal mixers to evaporation kettle and supply tank for efficient temperature control, evaporation, purging and cooling
5. Added chiller for better temperature control and vapor condensing
6. Added jacketed vacuum and supply tanks for better temperature control
7. Added pressure pump for optional filtration flexibility
8. Added steam extraction option

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A processing system for biomass material, the system comprising:
a material vessel capable of receiving the biomass material;
an evaporator vessel coupled to the material vessel;
a condenser coupled to the evaporator vessel;
a storage tank for solvent coupled to the material vessel;
a source of reduced air pressure coupled to the condenser and selectively coupleable to the storage tank, the reduced air pressure source capable of creating a reduced air pressure in the condenser that is applied to the material vessel through the evaporator vessel to draw solvent from the solvent tank through the biomass material to thereby draw a fluid mixture of solvent and oil from the biomass material into the evaporator vessel;
a source of positive air pressure coupled to the storage tank that is capable of creating an increased air pressure in the storage tank to push solvent from the solvent tank through the biomass material to thereby draw a fluid mixture of solvent and oil from the biomass material into the evaporator vessel; and
a heating device coupled to the material vessel and the evaporator vessel and capable of applying heat to the material vessel and to the evaporator vessel.

2. The system of claim 1 further comprising a cooling device coupled to the storage tank and capable of cooling solvent in the storage tank.

3. The system of claim 2 wherein the cooling device is coupled to the condenser to transfer heat with the condenser via an exchange of fluids.

4. The system of claim 1 wherein the source of reduced air pressure comprises a vacuum tank coupled to the condenser and selectively coupled to the storage tank, and a vacuum pump coupled to the vacuum tank.

5. The system of claim 1 further comprising a molecular filter having an input coupled to an output of the material vessel and an output coupled to an input of the evaporator condenser.

6. The system of claim 5 wherein the molecular filter has its input also coupled to an output of the evaporator vessel, and the molecular filter comprises a molecular sieve.

7. A method of extracting fluids from biomass material using a processing system for biomass material that includes a material vessel capable of receiving the biomass material, an evaporator vessel coupled to the material vessel, a condenser coupled to the evaporator vessel, a storage tank for solvent coupled to the material vessel, a source of reduced air pressure coupled to the condenser and selectively coupleable to the storage tank, the vacuum source capable of creating a reduced air pressure in the condenser that is applied to the material vessel through the evaporator vessel to draw solvent from the solvent tank through the biomass material to thereby draw a fluid mixture of solvent and oil from the biomass material into the evaporator vessel, a source of positive air pressure coupled to the storage tank that is capable of creating an increased air pressure in the storage tank to push solvent from the solvent tank through the biomass material to thereby draw a fluid mixture of solvent and oil from the biomass material into the evaporator vessel, and a source of heat coupled to the material vessel and the evaporator vessel and capable of applying heat to the material vessel and to the evaporator vessel, the method comprising:
supplying solvent to the storage tank;
supplying the biomass material to the material vessel;
applying one of either a reduced air pressure with the vacuum source or increased air pressure from the pressure source to the storage tank to force the solvent through the biomass material in the material vessel and draw or push, respectively, a fluid mixture of solvent and biomass oils from the biomass material into the evaporator vessel; and
heating the material vessel and the evaporator vessel to dry remaining biomass material in the material vessel and to heat the fluid mixture in the evaporator vessel to separate solvent from the fluid mixture.

8. The method of claim 7 wherein the heating the fluid mixture in the evaporator chamber generates vapor solvent that is condensed to liquid solvent in the condenser.

9. The method of claim 8 further comprising:
receiving the liquid solvent from the condenser into the vacuum tank; and
draining the liquid solvent from the vacuum tank into the storage tank.

10. The method of claim 9 wherein the applying pressure or reduced air pressure comprises applying increased air pressure to the storage tank with air pressure from a pressure pump.

11. The method of claim 7 wherein applying increased air pressure or reduced air pressure comprises applying a continuous reduced air pressure to the condenser to draw solvent from the storage tank through the material vessel and draw the fluid mixture from the material vessel into the evaporator vessel and to draw vaporized solvent from the evaporator vessel into the condenser and to the vacuum tank.

12. The method of claim 11 further comprising exchanging fluids between the condenser and a cooling device to transfer heat from the cooling device to the condenser.

13. The method of claim 8 further comprising filtering the vapor solvent with a molecular filter prior to condensing the vapor solvent in the condenser.

14. A process of extracting fluid from biomass material using a system that includes a material vessel capable of receiving the biomass material, an evaporator vessel coupled to the material vessel, a condenser coupled to the evaporator vessel, a storage tank for solvent coupled to the material vessel, a vacuum pump coupled to the condenser and selectively coupleable to the storage tank, the vacuum pump capable of creating a reduced air pressure in the condenser that is applied to the material vessel through the evaporator vessel to draw solvent from the solvent tank through the biomass material to thereby draw a fluid mixture of solvent and oil from the biomass material into the evaporator vessel, a source of pressure coupled to the storage tank that is capable of creating an increased air pressure in the storage tank to push solvent from the solvent tank through the biomass material to thereby draw a fluid mixture of solvent and oil from the biomass material into the evaporator vessel, a heating source coupled to the material vessel and the evaporator vessel and capable of applying heat to the material vessel and to the evaporator vessel, and a cooling source coupled to the storage tank and the condenser to cool solvent in the storage tank, the process comprising:
introducing biomass material into the material vessel;
extracting fluid from the biomass material using solvent from the storage tank by one of either:
creating a continuous reduced air pressure with the vacuum pump in the condenser that is in fluid communication with the material vessel to draw solvent from the storage tank into the material vessel and through the biomass material to generate a fluid mixture of solvent and biomass oil that is drawn into the evaporator vessel, or
creating a continuous increased air pressure with the pressure pump in the storage tank to push solvent into the material vessel and through the biomass material in the material vessel to generate a fluid mixture of solvent and biomass oil that is pushed into the evaporator vessel;
extracting the solvent from the fluid mixture in the evaporator vessel by heating the evaporator vessel with the heating source to generate vaporized solvent from the fluid mixture in the evaporator vessel; and
returning the vaporized solvent to the storage tank in liquid form by one from among:
drawing the vaporized solvent into the condenser using the continuous reduced air pressure generated by the vacuum pump to condense the vaporized solvent into a liquid solvent, then drawing the liquid solvent into the vacuum tank, shutting off the vacuum pump, and draining the liquid solvent from the vacuum tank into the storage tank;
pushing the vaporized solvent into the condenser using the continuous increased air pressure generated by the pressure pump to condense the vaporized solvent into a liquid solvent, then pushing the liquid solvent into the vacuum tank and thence into the storage tank; and
shutting off the vacuum pump when reduced air pressure was used and allowing the air pressure to increase to atmospheric pressure in the system and push the vaporized solvent to the vacuum tank to be drained into the storage tank.

15. The process of claim 14, further comprising exchanging fluids between the condenser and the cooling device to transfer heat from the cooling device to the condenser.

16. The process of claim 15 comprising filtering the liquid solvent with a molecular filter during the drawing the vaporized solvent into the condenser.
